(19) United States
(12) Patent Application Publication
(10) Pub. No.: US 2022/0129572 A1
(43) Pub. Date: Apr. 28, 2022

(54) INFORMATION PROCESSING DEVICE AND NON-TRANSITORY COMPUTER READABLE MEDIUM

(71) Applicant: FUJIFILM Business Innovation Corp., Tokyo (JP)

(72) Inventor: Kazuya TANAKA, Kanagawa (JP)

(73) Assignee: FUJIFILM Business Innovation Corp., Tokyo (JP)

(21) Appl. No.: 17/336,390

(22) Filed: Jun. 2, 2021

(30) Foreign Application Priority Data
Oct. 26, 2020 (JP) 2020-179175

(51) Int. Cl. G06F 21/62

(52) U.S. Cl. CPC G06F 21/6209

(57) ABSTRACT

An information processing device includes: a processor configured to: receive creation of one or more attributes associated with a file, the creation having been made by a user; acquire an access level indicating a strength of a right to change an attribute of the file, the right being owned by the user; store, for the created one or more attributes, an access level corresponding to the user who has made the creation together with a received creation content; and when an access level corresponding to a user who attempts to change an attribute of the file is equal to or higher than the access level currently stored for the attribute to be changed, reflect a received change content in the attribute.

### CROSS-REFERENCE TO RELATED APPLICATIONS

This application is based on and claims priority under 35 USC 119 from Japanese Patent Application No. 2020-179175 filed Oct. 26, 2020.

### BACKGROUND

### (i) Technical Field

The present disclosure relates to an information processing device and a non-transitory computer readable medium.

### (ii) Related Art

For example, JP-A-2008-83884 discloses an information processing system capable of setting an access right for each of plural attributes. A storage unit of the information processing system stores information and the plural attributes of the information. An access right setting unit sets an access right for each attribute stored in the storage unit according to an access right of corresponding information.

### SUMMARY

By the way, when the access right is to be set to each of attributes of a certain file, it is complex to perform setting on the individual attributes. To solve this complexity, JP-A-2008-83884 has proposed a method of inheriting a right to access a file having attributes to the attributes. In this case, the rights to access the attributes are the same as that to access the file. Thus, it is difficult to set the rights to access the attributes to be different from the right to access the file.

Aspects of non-limiting embodiments of the present disclosure relate to providing an information processing device and a non-transitory computer readable medium capable of setting rights to change individual attributes of a file as rights different from a right to change the file itself, while saving time and effort to individually set the rights to change the attributes.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including: a processor configured to: receive creation of one or more attributes associated with a file, the creation having been made by a user; acquire an access level indicating a strength of a right to change an attribute of the file, the right being owned by the user; store, for the created one or more attributes, an access level corresponding to the user who has made the creation together with a received creation content; and when an access level corresponding to a user who attempts to change an attribute of the file is equal to or higher than the access level currently stored for the attribute to be changed, reflect a received change content in the attribute.

### BRIEF DESCRIPTION OF THE DRAWINGS

Exemplary embodiment(s) of the present disclosure will be described in detail based on the following figures, wherein:

FIG. 1 is a diagram showing an example of an overall configuration of a document management system according to a first exemplary embodiment;

FIG. 2 is a block diagram showing an example of a hardware configuration of a server according to the first exemplary embodiment;

FIG. 3 is a block diagram showing an example of a configuration of a storage unit in the server according to the first exemplary embodiment;

FIG. 4 is a flowchart of an example of an attribute creation process according to the first exemplary embodiment;

FIGS. 5A to 5C show examples in which an access level is stored for each attribute in the first exemplary embodiment, where FIG. 5A shows an example in which the access levels are set at a time of file creation, FIG. 5B shows an example in which the access levels are set at a time of approval, and FIG. 5C shows an example in which changing of the attributes is allowed or prohibited in accordance with an access level;

FIG. 6 is a flowchart of an example of an attribute changing process according to the first exemplary embodiment;

FIG. 7 is a flowchart of an example of an attribute changing process according to a second exemplary embodiment;

FIG. 8 is a block diagram showing an example of a configuration of a storage unit in a server according to a third exemplary embodiment;

FIG. 9A and FIG. 9B show information stored in the storage unit according to the third exemplary embodiment, where FIG. 9A shows an example of a content of user data, and FIG. 9B shows an example of a content of group data;

FIG. 10 is a flowchart of an example of a setting process according to the third exemplary embodiment;

FIG. 11 is a flowchart of an example of an attribute creation process according to the third exemplary embodiment;

FIG. 12 is a flowchart of an example of a creator access level acquisition process according to the third exemplary embodiment;

FIG. 13 is a flowchart of an example of an attribute changing process according to the third exemplary embodiment;

FIG. 14 is a flowchart of an example of a changer access level acquisition process according to the third exemplary embodiment;

FIG. 15 is a flowchart of an example of a hierarchizing process according to a fourth exemplary embodiment;

FIG. 16 shows an example of hierarchical data stored in a storage unit according to the fourth exemplary embodiment;

FIG. 17 is a flowchart of an example of a creator access level acquisition process according to the fourth exemplary embodiment; and

FIG. 18 is a flowchart of an example of a changer access level acquisition process according to the fourth exemplary embodiment.

### DETAILED DESCRIPTION

Hereinafter, a document management system to which an information processing device of each of exemplary embodiments of the present disclosure is applied will be described with reference to the accompanying drawings.

### First Exemplary Embodiment

### Configuration

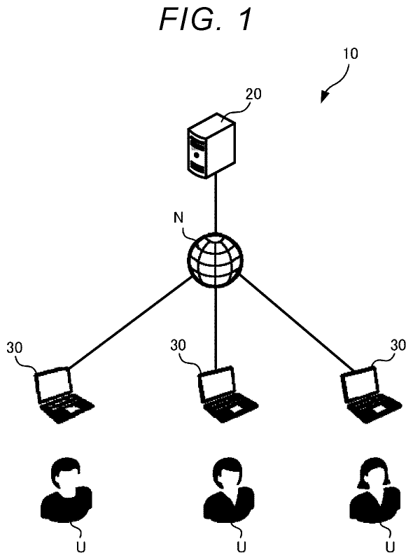

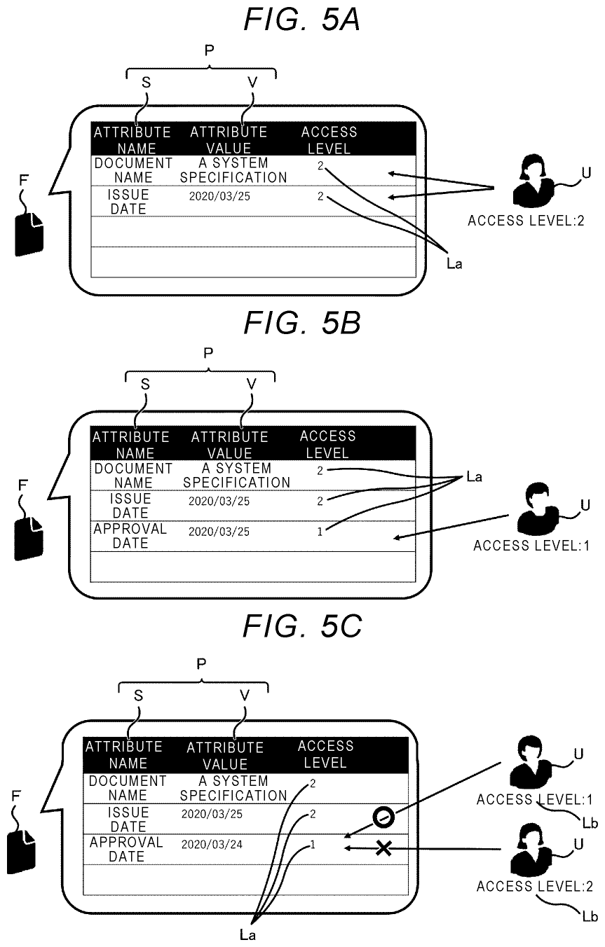

As shown in FIG. 1, a document management system 10 according to a first exemplary embodiment includes a server 20 (an example of an information processing device) and plural personal computers (PCs) 30 operated by users U. The server 20 is configured as, for example, a cloud server that stores a file F (see FIG. 5) created by the PCs 30. The server 20 and the PCs 30 are connected to each other via a network N.

In the document management system 10 of the present exemplary embodiment, the three PCs 30 are connected to the one server 20. The number of servers 20 and the number of PCs 30 are not limited thereto.

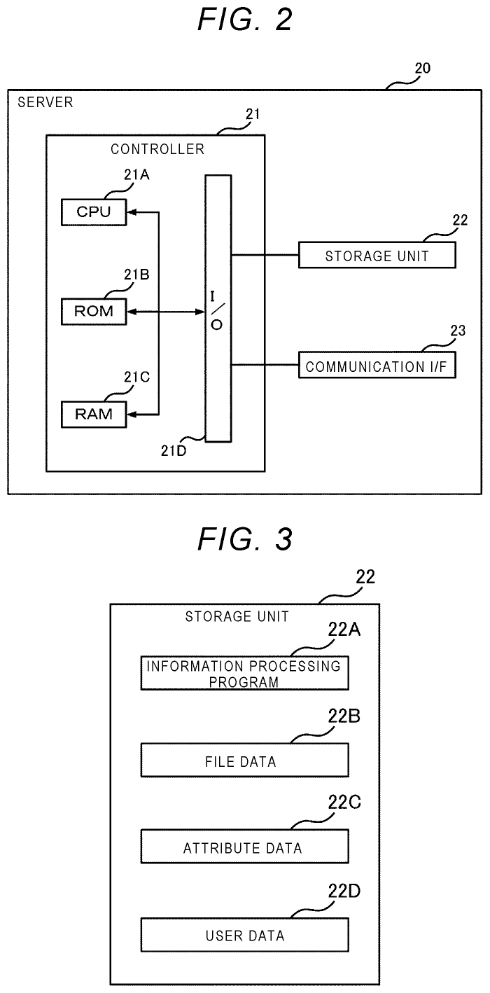

FIG. 2 is a block diagram showing an example of a hardware configuration of the server 20 according to the present exemplary embodiment.

As shown in FIG. 2, the server 20 according to the present exemplary embodiment includes a controller 21, a storage unit 22, and a communication I/F 23.

The controller 21 includes a central processing unit (CPU) 21A, a read only memory (ROM) 21B, a random access memory (RAM) 21C, and an input and output interface (I/O) 21D. The CPU 21A, the ROM 21B, the RAM 21C, and the I/O 21D are connected to each other via a bus. The CPU 21A is an example of a processor.

Functional units including the storage unit 22 and the communication I/F 23 are connected to the I/O 21D. The functional units can communicate with the CPU 21A via the I/O 21D.

The controller 21 may be configured as a sub controller that controls a part of operations of the server 20, or may be configured as a part of a main controller that controls the entire operation of the server 20.

The storage unit 22 is, for example, a hard disk drive (HDD), a solid state drive (SSD), a flash memory or the like. As shown in FIG. 3, the storage unit 22 stores an information processing program 22A, file data 22B, attribute data 22C, and user data 22D.

The information processing program 22A is a program for executing various processes according to the present exemplary embodiment. The information processing program 22A according to the present exemplary embodiment is installed in the storage unit 22 in advance. It is noted that the present disclosure is not limited thereto. For example, the information processing program 22A may be stored in a non-volatile storage medium or be distributed via the network N, and appropriately installed in the storage unit 22. Examples of the non-volatile storage medium include a compact disc read only memory (CD-ROM), a magnetooptical disc, an HDD, a digital versatile disc read only memory (DVD-ROM), a flash memory, and a memory card.

The file data 22B is data that stores the file F such as a document, a table, a slide, an image, and a drawing.

The attribute data 22C is data that stores one or plural attributes P associated with the file F. As shown in FIGS. 5A to 5C, each attribute P is information indicating an outline, a state, a characteristic, and the like of the file F. Each attribute P includes an attribute name S and an attribute value V. For example, as shown in FIG. 5A, a file name is stored for an attribute value V of an attribute P whose attribute name S is “document name”. A creation date of the file F is stored for an attribute value V of an attribute P whose attribute name S is “issue date”. The attribute data 22C stores an access level corresponding to the attribute P (which will be described later) together with the attribute P. The attribute data 22C of the present exemplary embodiment is provided separately from the file data 22B. The present disclosure is not limited thereto. The attribute data 22C may be included in the file data 22B.

The user data 22D is data that stores an account that specifies each user U connected to the server 20 and an access level assigned to the account. The access level is information indicating a strength of a right, owned by the user U, to change the attributes P of the file F. In the present exemplary embodiment, the right increases as the number of the access level decreases. That is, when the access level is “1”, the access level is higher than an access level of “2”. A method for specifying the user U is not limited to the account. A login name of the user U, a unique ID of the PC 30 used by the user U, or the like may be used.

As shown in FIG. 2, the communication I/F 23 is an interface for communicating with the PC 30 through the network N. The network N includes a public line such as the Internet.

In the server 20 configured as described above, the CPU 21A reads the information processing program 22A stored in the storage unit 22, and executes the information processing program 22A using the RAM 21C as a work area, thereby executing various processes.

### Process Flow

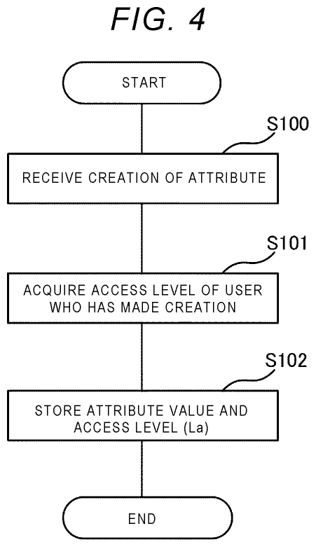

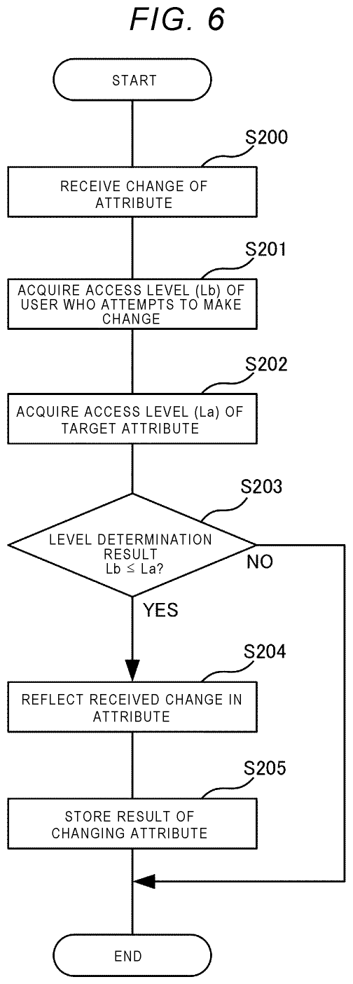

A flow of an attribute creation process executed on the server 20 according to the present exemplary embodiment when an attribute P is to be created will be described with reference to FIG. 4. Also, a flow of an attribute changing process executed on the server 20 according to the present exemplary embodiment when an attribute P is to be changed will be described with reference to FIG. 6. The attribute creation process and the attribute changing process are executed in accordance with operations on the file F by the PC 30.

First, the attribute creation process will be described. The attribute creation process is a process executed when the user U creates the attribute P on the PC 30. In the present exemplary embodiment, cases where the attribute P is created include (1) a case where only the attribute name S is created and the attribute value V is not input, (2) a case where the attribute value V is input to an attribute P that has already been prepared but does not have the attribute value V, and (3) a case where the attribute name S is created and the attribute value V is input.

In step S100 of FIG. 4, the CPU 21A receives the creation of the attribute P for the file F from the PC 30.

In step S101, the CPU 21A acquires the access level of the user U who has created the attribute P. Specifically, the CPU 21A refers to the user data 22D and acquires the access level corresponding to the account of the user U who creates the attribute P.

In step S102, the CPU 21A stores the attribute value V and an access level La in the attribute data 22C. Here, the access level La stored in the attribute data 22C is the access level of the user U acquired in step S101. Then, the attribute creation process is ended.

FIG. 5A shows an example in which the file F is newly created. Along with the creation of the file F, the attribute creation process is executed. As shown in FIG. 5A, a file name is stored in an attribute value V corresponding to an attribute name S having a “document name”, and a creation date is stored in an attribute value V corresponding to an attribute name S having an “issue date”. The access level of the user U who creates the attribute P is set for the attribute P including the “document name” and the attributes P including the “issue date”. Here, the user U who creates the attribute P including the “document name” and the attribute P including the “issue date” is the user U who creates the file F, and an access level “2” of the user U is set in the example of FIG. 5A.

Next, a result of the attribute creation process executed when a user U having an access level higher than that of the user U who has created the file F approves the file F will be described. In this case, as shown in FIG. 5B, an attribute P whose attribute name S is “approval date” is newly created, and a date on which the user U makes an approval is stored for an attribute value V of the attribute P. An access level of the user U who has created the attribute P (that is, “1” in the example of FIG. 5B) is set for the attribute P including the “approval date”.

Next, the attribute changing process will be described. The attribute changing process is a process executed when the user U is to change the attribute P on the PC 30.

In step S200 of FIG. 6, the CPU 21A receives a change of the attribute P from the PC 30.

In step S201, the CPU 21A acquires an access level Lb of the user U who attempts to change the attribute P. Specifically, the CPU 21A refers to the user data 22D and acquires the access level corresponding to the account of the user U who attempts to change the attribute P as the access level Lb.

In step S202, the CPU 21A acquires the access level La of the attribute P to be changed. Specifically, the CPU 21A refers to the attribute data 22C and acquires the access level La stored in the attribute P to be changed.

In step S203, the CPU 21A compares the access levels to determine whether Lb is equal to or less than La. When the CPU 21A determines that Lb is equal to or less than La (YES in step S203), the process proceeds to step S204. On the other hand, when the CPU 21A determines that Lb is not equal to or less than La, that is, Lb is larger than La (NO in step S203), the attribute changing process is ended. Here, Lb is equal to or less than La means “equal to or higher than a currently stored access level”.

In step S204, the CPU 21A reflects the received change in the attribute P. That is, the CPU 21A updates the attribute value V of the attribute P to be changed to a received attribute value V.

In step S205, the CPU 21A stores a change result of the attribute P. That is, the CPU 21A stores the reflected attribute value V in the attribute data 22C. Then, the attribute changing process is ended.

FIG. 5C shows an example of the result of the attribute changing process executed when the created attribute P is changed. As shown in FIG. 5C, when attempting to change the attribute P whose attribute name S is “approval date”, the user U whose access level is equal to or less than the access level La (specifically, “1”) to which the attribute P including the “approval date” is set, that is, whose access level is “1” can change the attribute value V of the “approval date”. On the other hand, the user U whose access level is larger than the access level La (specifically, “1”) to which the attribute P including the “approval date” is set, that is, whose access level is “2” or more cannot change the attribute value V of the “approval date”.

### Summary of First Exemplary Embodiment

In the server 20 of the present exemplary embodiment, when receiving creation of one or plural attributes P associated with a file F by the user U, the CPU 21A acquires an access level corresponding to the user U. Then, the CPU 21A stores the access level corresponding to the user U who has created the one or plural attributes P in the storage unit 22 together with a received creation content. Then, upon receipt of a change of an attribute P made by the user U, the CPU 21A reflects a received change content in the attribute P when the access level Lb corresponding to the user U who attempts to make the change is equal to or higher than the access level La currently stored for the attribute P to be changed.

When changing rights are set for individual attributes in a certain file, it is complex to individually perform setting for the attributes. As a solution to the complexity, a method of inheriting a right to change a file having the attributes to the attributes has been proposed. However, in this case, rights to change the attributes are the same as the right to change the file. Therefore, it is difficult to set the rights to change the individual attributes to be different from the right to change the file.

On the other hand, according to the present exemplary embodiment, the rights to change the attributes P can be set simultaneously with the creation of the attributes P. Thus, it is possible to save time and effort of individually setting the rights to change the attributes P of each file F. According to the present exemplary embodiment, the attribute P can be set to the access level of the user U different from the user U who has created the file F. That is, the rights to change the individual attributes P of each file F can be set as rights different from the right to change the file F itself.

### Second Exemplary Embodiment

A server 20 of a second exemplary embodiment is different from the server 20 of the first exemplary embodiment in the flow of the attribute changing process. Hereinafter, differences from the first exemplary embodiment will be described. Since the configuration is the same as that of the first exemplary embodiment, description thereof will be omitted.

### Process Flow

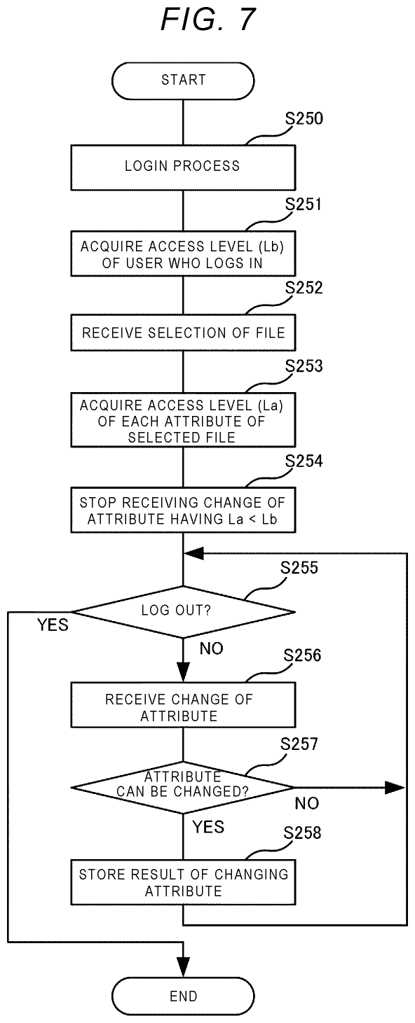

Next, an attribute changing process according to the present exemplary embodiment will be described with reference to FIG. 7.

In step S250 of FIG. 7, the CPU 21A executes a login process. The login process is executed in response to a user U operating a PC 30 to make a login request.

In step S251, the CPU 21A acquires an access level Lb of the user U who logs in. Specifically, the CPU 21A refers to the user data 22D and acquires an access level corresponding to an account of the user U who logs in as the access level Lb.

In step S252, the CPU 21A receives a selection of a file F.

In step S253, the CPU 21A acquires an access level La of each of attributes P of the selected file F. Specifically, the CPU 21A refers to the attribute data 22C and acquires the access level La stored in each of the attributes P of the selected file F.

In step S254, the CPU 21A stops receiving a change of an attribute P having La less than Lb. As a result, for example, an attribute P that cannot be changed is displayed on a screen of the PC 30 in a gray-out manner, to prevent reception of the operation by the user U. Here, Lb is larger than La (La is less than Lb) means that “lower than a currently stored access level”.

In step S255, the CPU 21A determines whether a logout request is received. When the CPU 21A determines that the logout request is received (YES in step S255), the attribute changing process is ended. On the other hand, when the CPU 21A determines that the logout request is not received (NO in step S255), the process proceeds to S256.

In step S256, the CPU 21A receives a change of an attribute P from the PC 30.

In step S257, the CPU 21A determines whether the attribute P whose change has been received can be changed. When the CPU 21A determines that the attribute P whose change has been received can be changed (YES in step S257), the process proceeds to step S258. On the other hand, when the CPU 21A determines that the attribute P whose change has been received cannot be changed (NO in step S257), the process returns to step S255.

In step S258, the CPU 21A stores a change result of the attribute P. That is, the CPU 21A stores the reflected attribute value V in the attribute data 22C. Then, the process returns to step S255.

### Summary of Second Exemplary Embodiment

In the server 20 of the present exemplary embodiment, when receiving creation of one or plural attributes P associated with a file F by the user U, the CPU 21A acquires an access level corresponding to the user U. Then, the CPU 21A stores the access level corresponding to the user U who has created the one or plural attributes P in the storage unit 22 together with a received creation content. Then, the CPU 21A prevents a user U who has an access level Lb and who is attempting to access a file F from changing an attribute P having an access level La which is currently stored for the file F and which is less than the access level Lb. Specific examples of the phrase “preventing the change” include a case where a change instruction from the user U is not received and a case where a change instruction is received but is not reflected.

According to the present exemplary embodiment, whether to allow changing of the attribute P is controlled at a stage of accessing the file F, and thus, similar effect as that of the first exemplary embodiment is achieved.

### Third Exemplary Embodiment

A server 20 of the third exemplary embodiment is different from that of the first exemplary embodiment in a method of acquiring an access level. Hereinafter, differences from the first exemplary embodiment will be described. The same elements as those of the first exemplary embodiment will be denoted by the same reference numerals, the description thereof will be omitted.

### Configuration

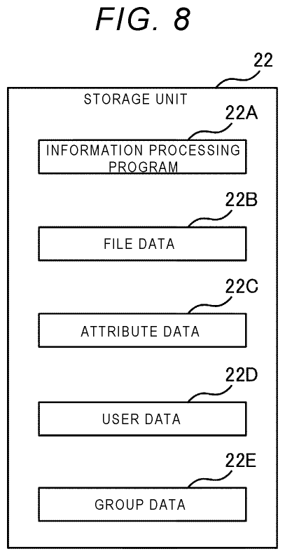

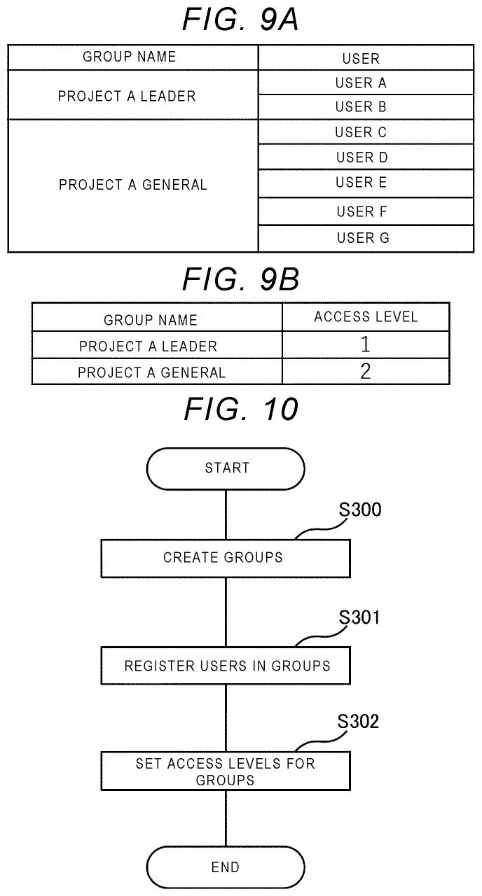

As shown in FIG. 8, a storage unit 22 according to the present exemplary embodiment stores an information processing program 22A, file data 22B, attribute data 22C, user data 22D, and group data 22E.

As illustrated in FIG. 9A, the user data 22D of the present exemplary embodiment stores a correspondence relationship between users U and groups to which the users U belong. The user data 22D is an example of correspondence information.

As illustrated in FIG. 9B, the group data 22E stores a correspondence relationship between the groups to which the users U belong and access levels assigned to the groups.

### Process Flow

First, a setting process of registering the users U in the groups and setting the access levels on a server 20 of the present exemplary embodiment will be described with reference to FIG. 10. Each step in the setting process is executed based on an instruction from the user U or the administrator.

In step S300 of FIG. 10, the CPU 21A creates groups.

In step S301, the CPU 21A registers users U in the groups. Accordingly, as shown in FIG. 9A, the user data 22D is created.

In step S302, the CPU 21A sets access levels for the groups. Accordingly, as shown in FIG. 9B, the group data 22E is created. Then, the setting process is ended.

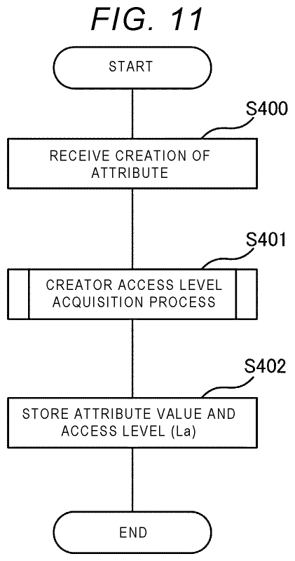

Next, an attribute creation process according to the present exemplary embodiment will be described with reference to FIG. 11.

A process of step S400 in FIG. 11 is the same as that of step S100 in FIG. 4.

In step S401, a creator access level acquisition process is executed. Details of this process will be described later.

The process of step S402 is the same as that of step S102 in FIG. 4. Then, the attribute creation process is ended.

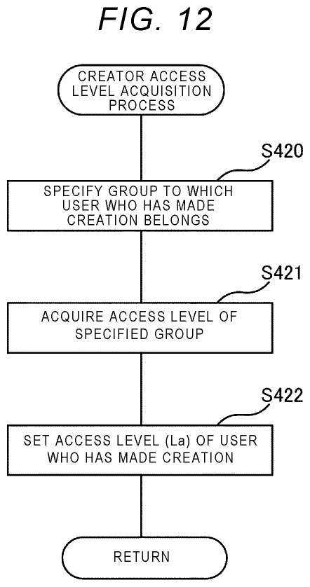

The creator access level acquisition process at step S401 will be described with reference to FIG. 12.

In step S420 of FIG. 12, the CPU 21A specifies a group to which the user U who has made the creation belongs. Specifically, the CPU 21A refers to the user data 22D and specifies a group including the user U as a belonging group.

In step S421, the CPU 21A acquires the access level of the specified group. Specifically, the CPU 21A refers to the group data 22E and acquires the access level of the specified group.

In step S422, the CPU 21A sets an access level La of the user U who has created the attribute P to the access level of the group specified in step S421. Then, the process returns to the attribute creation process in FIG. 11.

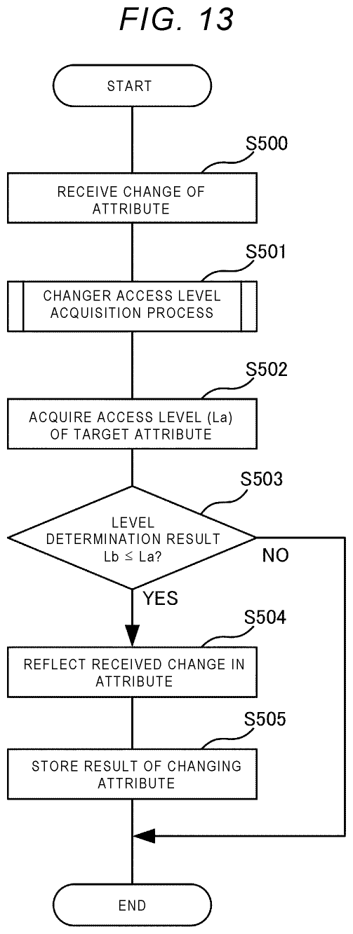

Next, an attribute changing process according to the present exemplary embodiment will be described with reference to FIG. 13.

The process of step S500 in FIG. 13 is the same as that of step S200 in FIG. 6.

In step S501, a changer access level acquisition process is executed. Details of this process will be described later.

The processes of step S502 to step S505 are the same as those of step S202 to step S205 in FIG. 6. Then, the attribute changing process is ended.

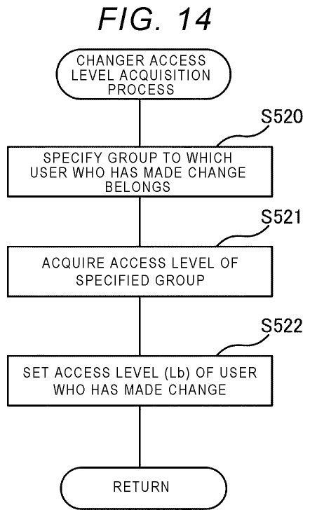

The changer access level acquisition process at step S501 will be described with reference to FIG. 14.

In step S520 of FIG. 14, the CPU 21A specifies a group to which the user U who attempts to make a change belongs. Specifically, the CPU 21A refers to the user data 22D and specifies a group including the user U as a belonging group.

In step S521, the CPU 21A acquires an access level of the specified group. Specifically, the CPU 21A refers to the group data 22E and acquires the access level of the specified group.

In step S522, the CPU 21A sets an access level Lb of the user U who attempts to change an attribute P to the access level of the group specified in step S521. Then, the process returns to the attribute changing process in FIG. 13.

### Summary of Third Exemplary Embodiment

In the server 20 of the present exemplary embodiment, the CPU 21A acquires the access level of each user U from the access level set for the group to which the user U belongs. Therefore, according to the present exemplary embodiment, a burden of setting can be reduced as compared with the case where the access level is set for each user U.

In the present exemplary embodiment, the access level of each group is set in the setting process. The present disclosure is not limited thereto. For example, the user data 22D may be acquired from the PC 30 or another device connected to the network N. Accordingly, it is possible to further reduce the burden of setting the access levels as compared with a case where the access level is further set for the group after the group is registered.

### Fourth Exemplary Embodiment

A server 20 of a fourth exemplary embodiment is different from those of the first and third exemplary embodiment in the access level acquisition method. Hereinafter, differences from the first exemplary embodiment will be described. The same elements as those of the first exemplary embodiment will be denoted by the same reference numerals, the description thereof will be omitted.

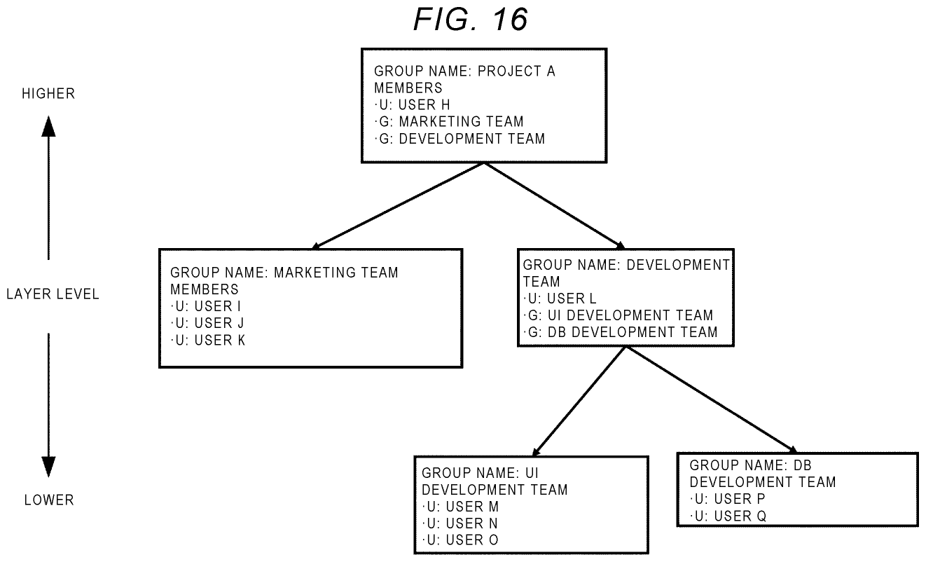

In the present exemplary embodiment, whether to allow changing of the attribute P is controlled using hierarchical data instead of the correspondence information between the users U and the access levels or the correspondence information between the groups and the access levels. The hierarchical data is information that hierarchically represents users U and groups (see FIG. 16).

The hierarchical data may be set mainly for a purpose different from management of rights to change attributes P of a file F. For example, in a system for personnel management, sales management, and/or project management, the hierarchical data may be set for a purpose of facilitating right management and data analysis. The hierarchical data may be information stored in a server that is different from the server 20 and is provided in the document management system 10.

### Process Flow

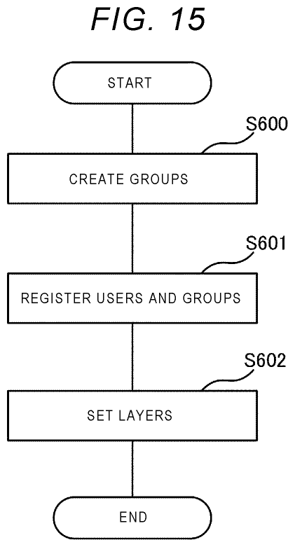

First, a hierarchizing process of setting hierarchized groups in the server 20 according to the present exemplary embodiment will be described with reference to FIG. 15. Each step in the hierarchizing process is executed based on an instruction from the administrator.

In step S600 of FIG. 15, the CPU 21A creates groups.

In step S601, the CPU 21A registers users U and other groups in the group.

In step S602, the CPU 21A sets layers for the groups. Specifically, the CPU 21A associates the users U belonging to a specific group and the other groups based on an operation of the administrator of the document management system 10. As a result, the hierarchical data shown in FIG. 16 is created. Then, the hierarchizing process is ended.

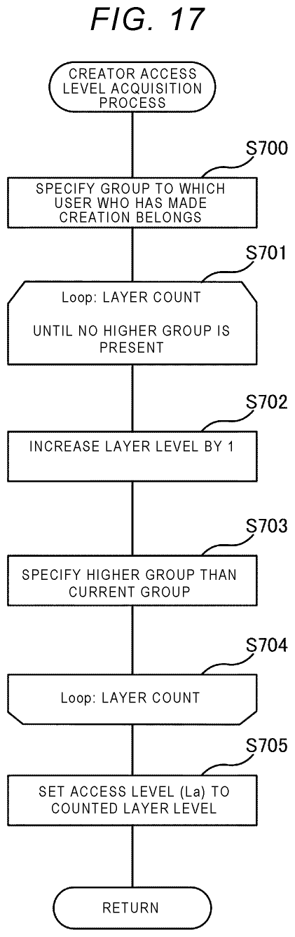

Next, a creator access level acquisition process according to the present exemplary embodiment is described with reference to FIG. 17.

The process of step S700 in FIG. 17 is the same as that of step S420 in FIG. 12.

From step S701 to step S704, the CPU 21A executes a “layer count” loop. The loop is executed until no higher group than the specified group is present.

In step S702, the CPU 21A increases a layer level by 1.

In step S703, the CPU 21A specifies a higher group than a current group.

Then, when no higher group is present, the process proceeds to step S705.

In step S705, the CPU 21A sets an access level La of an attribute P at the counted layer level. Then, the process returns to the attribute creation process in FIG. 11.

Here, a specific description will be made with reference to hierarchical data shown in FIG. 16. When a group name “development team” is specified in step S700, the layer level is set to “1” in step S702 of the first round, and a higher group “project A member” is specified in step S703. Then, when the layer level is incremented to “2” in step S702 of the second round, the “project A member” group does not have any higher group. Thus the “layer count” loop is exited. As a result, the access level La of the “development team” group is set to 2.

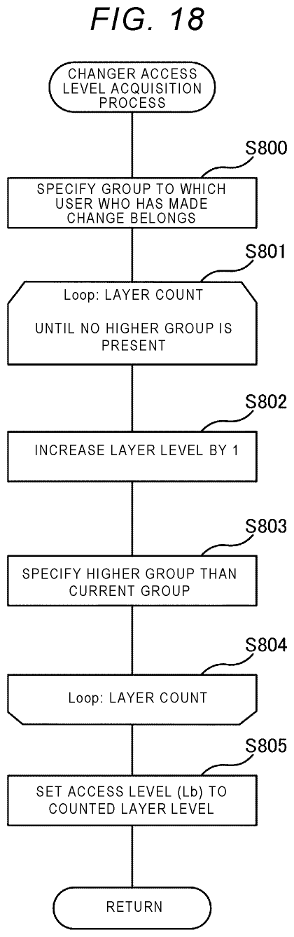

Next, the changer access level acquisition process according to the present exemplary embodiment will be described with reference to FIG. 18.

The process of step S800 in FIG. 18 is the same as that of step S520 in FIG. 14.

From step S801 to step S804, the CPU 21A executes a “layer count” loop. The processes of step S801 to step S804 is the same as those of step S701 to step S704 in FIG. 17.

In step S805, the CPU 21A sets an access level Lb of a user U who attempts to change the attribute P to the counted layer level. Then, the process returns to the attribute changing process in FIG. 13.

Here, a specific description will be made with reference to the hierarchical data shown in FIG. 16. When a group name “DB development team” is specified in step S800, the layer level is set to “1” in step S802 of the first round, and a higher group “development team” is specified in step S803. Then, when the layer level is incremented to “2” in step S802 of the second round, a higher group “project A member” is specified in step S803. Then, when the layer level is incremented to “3” in step S802 of the third round, the “project A member” group does not have any higher group. Thus, the “layer count” loop is exited. As a result, the access level Lb of the “DB development team” group is set to 3.

### Summary of Fourth Exemplary Embodiment

In the server 20 according to the present exemplary embodiment, the correspondence information between the users U and the groups to which the users U belong in the storage unit 22 is information that hierarchically represents the users U and the groups. Therefore, according to the present exemplary embodiment, as compared with a case where access levels are set for information that are not hierarchized, in other words, as compared with a case where an access level is individually set for each group, it is easy to set corresponding access levels for groups.

In particular, in the present exemplary embodiment, the CPU 21A specifies a group to which the user U whose access level is to be acquired belongs from plural groups, and sets a layer level indicating a position of the specified group in a hierarchy structure as the access level. That is, according to the present exemplary embodiment, the layer level of the group can be used as the access level.

According to the present exemplary embodiment, the layer level of the specified group is set as the access level. The present invention is not limited thereto. The layer level itself may be treated as information indicating the strength of the right to change the attribute P of the file F. That is, in the attribute creation process, the created attribute P and the layer level corresponding to the attribute P are stored, and in the attribute changing process, it is determined whether the attribute P to be changed by the user U can be changed based on the layer level.

### Fifth Exemplary Embodiment

A server 20 according to a fifth exemplary embodiment is different from that according to the first exemplary embodiment in a condition of the attribute creation process. Hereinafter, differences from the first exemplary embodiment will be described. Since the configuration is the same as that of the first exemplary embodiment, description thereof will be omitted.

In the attribute creation process of the first exemplary embodiment, the access level La is set in all cases where the attribute P is created. In an attribute creation process of the present exemplary embodiment, an access level La is not set when an attribute value V is not input even though an attribute name S is created.

Specifically, when a value of the attribute value V is not included in a changed content of an attribute P that the CPU 21A receives in step S100 of FIG. 4, it is prohibited in step S102 to set the access level La. That is, the CPU 21A stores only a newly created attribute name S in the attribute data 22C.

In the present exemplary embodiment, when an attribute value V is input to the attribute P to which the attribute value V has not yet been input, the CPU 21A executes the attribute creation process again, and sets the access level La of the attribute P to an access level corresponding to a user U who has input the attribute value V to the attribute P.

According to the present exemplary embodiment, when the access level of the user U who newly creates the attribute P is the highest, a situation in which a lower user U cannot set the attribute value V is prevented from happening. For example, an administrator of a system is given the highest right. In this case, when the administrator creates only an attribute name S, and an access level La is set, all general users having lower access levels cannot change an attribute P for which the attribute name S has been created. That is, an attribute value V cannot be input at all. On the other hand, according to the present exemplary embodiment, even when an access level of a user U who newly creates the attribute P is the highest, a lower user U can set an attribute value V.

In the present exemplary embodiment, when only the attribute name S is created, it is prohibited to set the access level La. The present disclosure is not limited thereto. The lowest access level may be set regardless of the access level of the user U who has created the attribute name S. In such a case, the lower users U can set the attribute value V.

### REMARK

In the above exemplary embodiments, the access level La is not changed once set for the attribute P. Alternatively, the access level La may be changeable. For example, when receiving a change of an attribute P made by a higher user U than an access level La currently stored for a file F, the CPU 21A may store an access level corresponding to the higher user U together with the received changed content. Accordingly, for example, when a user U having an access level higher than that of a user U who has approved the file F changes the attribute P related to the approval as a re-approval, it is prevented for the user U who has made the first approval to re-change the attribute P.

In the above exemplary embodiments, the strength of the changing right increases as the number of the access level decreases. The preset disclosure is not limited thereto. The strength of the changing right may increase as the number of the access level increases. In the fourth exemplary embodiment, ascending orders of the layer level and the access level may be reversed. That is, the access level may decrease as the layer level increases, and the access level may increase as the layer level decreases.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

A flow of the processing of the program described in the above-described exemplary embodiment is also an example, and an unnecessary step may be deleted, a new step may be added, or the processing order may be changed without departing from the gist.

The above-described exemplary embodiment has described a case in which the processing according to the exemplary embodiment is implemented with a software configuration by using the computer to execute the program, and the present disclosure is not limited thereto. The exemplary embodiment may be implemented by, for example, a hardware configuration or a combination of the hardware configuration and the software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising
a processor configured to:
receive creation of one or more attributes associated with a file, the creation having been made by a user;
acquire an access level indicating a strength of a right to change an attribute of the file, the right being owned by the user;
store, for the created one or more attributes, an access level corresponding to the user who has made the creation together with a received creation content; and
when an access level corresponding to a user who attempts to change an attribute of the file is equal to or higher than the access level currently stored for the attribute to be changed, reflect a received change content in the attribute.

2. The information processing device according to claim 1, wherein
the processor is configured to acquire the access level of each user from an access level set for a group to which the user belongs.

3. The information processing device according to claim 2, wherein
the processor is configured to:
acquire correspondence information between one or more groups and users belonging to the respective groups; and
set an access level for each of the one or more groups.

4. The information processing device according to claim 3, wherein
the correspondence information is information hierarchically representing the users and the groups to which the users belong.

5. The information processing device according to claim 4, wherein
the processor is configured to:
specify a group to which the user whose access level is to be acquired belongs from the groups; and
set a layer level indicating a hierarchical position of the specified group as the access level.

6. The information processing device according to claim 1, wherein
each of the one or more attributes comprises an attribute name and an attribute value, and
the processor is configured to, when an attribute name is created but an attribute value is not input during creation of an attribute, store the attribute name for the attribute without storing an access level corresponding to a user who has created the attribute.

7. The information processing device according to claim 2, wherein
each of the one or more attributes comprises an attribute name and an attribute value, and
the processor is configured to, when an attribute name is created but an attribute value is not input during creation of an attribute, store the attribute name for the attribute without storing an access level corresponding to a user who has created the attribute.

8. The information processing device according to claim 3, wherein
each of the one or more attributes comprises an attribute name and an attribute value, and
the processor is configured to, when an attribute name is created but an attribute value is not input during creation of an attribute, store the attribute name for the attribute without storing an access level corresponding to a user who has created the attribute.

9. The information processing device according to claim 4, wherein
each of the one or more attributes comprises an attribute name and an attribute value, and
the processor is configured to, when an attribute name is created but an attribute value is not input during creation of an attribute, store the attribute name for the attribute without storing an access level corresponding to a user who has created the attribute.

10. The information processing device according to claim 5, wherein
each of the one or more attributes comprises an attribute name and an attribute value, and
the processor is configured to, when an attribute name is created but an attribute value is not input during creation of an attribute, store the attribute name for the attribute without storing an access level corresponding to a user who has created the attribute.

11. The information processing device according to claim 6, wherein
the processor is configured to, when an attribute value is input to the attribute to which the attribute value is not input, store an access level corresponding to a user who inputs the attribute value in the attribute together with the input attribute value.

12. The information processing device according to claim 7, wherein
the processor is configured to, when an attribute value is input to the attribute to which the attribute value is not input, store an access level corresponding to a user who inputs the attribute value in the attribute together with the input attribute value.

13. The information processing device according to claim 8, wherein
the processor is configured to, when an attribute value is input to the attribute to which the attribute value is not input, store an access level corresponding to a user who inputs the attribute value in the attribute together with the input attribute value.

14. The information processing device according to claim 9, wherein
the processor is configured to, when an attribute value is input to the attribute to which the attribute value is not input, store an access level corresponding to a user who inputs the attribute value in the attribute together with the input attribute value.

15. The information processing device according to claim 10, wherein
the processor is configured to, when an attribute value is input to the attribute to which the attribute value is not input, store an access level corresponding to a user who inputs the attribute value in the attribute together with the input attribute value.

16. An information processing device comprising:
a processor configured to:
receive creation of one or more attributes associated with a file, the creation being made by a user;
acquire, from information hierarchically representing users and groups to which the users belong, a layer level indicating a hierarchical position of a groups to which the user belong;
store, for the created one or more attributes, a layer level corresponding to the group to which the user who has made the creation belongs together with a received creation content; and
when a layer level corresponding to a group to which a user who attempts to change an attribute of the file belongs is equal to or higher than the layer level currently stored for the attribute to be changed, reflect a received change content in the attribute.

17. A non-transitory computer readable medium storing a program that causes a computer to execute information processing, the information processing comprising:
receiving creation of one or more attributes associated with a file, the creation having been made by a user;
acquiring an access level indicating a strength of a right to change an attribute of the file, the right being owned by the user;
storing, for the created one or more attributes, an access level corresponding to the user who has made the creation together with a received creation content; and
when an access level corresponding to a user who attempts to change an attribute of the file is equal to or higher than the access level currently stored for the attribute to be changed, reflecting a received change content in the attribute.
